(19) United States
(12) Patent Application Publication
(10) Pub. No.: US 2018/0245852 A1
(43) Pub. Date: Aug. 30, 2018

(54) ELECTRIC IMMERSION ALUMINUM HOLDING FURNACE WITH CIRCULATION MEANS AND RELATED METHOD

(71) Applicant: Andritz Metals Inc., Canonsburg, PA (US)

(72) Inventor: Gordon KENNEDY, Sarasota, FL (US)

(21) Appl. No.: 15/758,048

(22) PCT Filed: Sep. 8, 2016
(86) PCT No.: PCT/US16/50713

§ 371 Date: Mar. 7, 2018

Related U.S. Application Data
(60) Provisional application No. 62/216,655, filed on Sep. 10, 2015.

(51) Int. Cl. F27D 27/00; B22D 41/01; B22D 7/00; F27B 3/04; F27D 3/14; F27B 14/06; H05B 3/82; H05B 3/44

(52) U.S. Cl. CPC F27D 27/00; B22D 41/01; B22D 7/005; H05B 3/44; F27D 3/14; F27B 14/06; H05B 3/82; F27B 3/045

(57) ABSTRACT

A process to hold molten aluminum alloy in a refractory lined vessel using heating elements disposed within ceramic immersion heating tubes to provide accurate temperature metal for the casting industry. The vessel is lined with multi thicknesses of high insulating refractory materials to minimize heat loss with contoured corners to allow smooth flow of circulating metal provided by a gear drive with rotary shaft and impeller. The heating elements are housed in a ceramic protection tube to prevent aluminum leakage which would result in element failure. The receiving and outlet wells are separated by refractory arches. An insulated inert gas purged cover is used over the heat chamber to reduce heat loss and allow for an inert purge gas to minimize surface oxidation. A thermocouple for temperature control is positioned in the exit chamber. A ceramic drain plug is provided to remove metal for maintenance.

### CROSS-RELATED APPLICATION

This application claims the benefit of U.S. Provisional Pat. App. No. 62/216,655 filed on Sep. 10, 2015, the entirely of which is incorporated herein by reference.

### BACKGROUND OF THE INVENTION

### 1. Technical Field

The present disclosure relates generally to immersion holding furnaces and more particularly to electric immersion holding furnaces configured to hold aluminum and aluminum alloys in the die cast aluminum industry.

### 2. Related Art

Aluminum comprises about 8% of the Earth's crust. The element can be found naturally as one or more aluminum oxide compounds in the mineral bauxite. Comprising over 70% of the Earth's crust, bauxite is primarily mined for aluminum production.

In the primary refining industry, operators seed a solution of crushed bauxite and sodium hydroxide with crystals to precipitate aluminum hydroxide. Operators then heat the aluminum hydroxide in a kiln to evaporate water and to convert the aluminum hydroxide into alumina (Al₂O₃). Equipment then mixes crushed bauxite with fluoride salts to lower the alumina's melting temperature. An electrolysis reduction cell may provide a direct current through the alumina and thereby isolate elemental aluminum at a negatively charged cathode. The oxygen in the alumina generally combines with carbon at the anode to produce carbon dioxide. Two parts alumina generally yields about one part aluminum.

Like many metals, aluminum's chemical and physical properties allow aluminum to be recovered and recycled on an industrial scale. As such, a secondary refining industry has arisen around the re-melting of scrap aluminum, which may contain various aluminum alloys along with various impurities. In both the primary and secondary industries, operators may alter the chemistry of the starting materials and any intermediate products to produce a desirable aluminum product. Scrap aluminum sources commonly include scrap castings, can stock, extrusions, and excess aluminum produced in smelting or product manufacturing processes.

In both the primary or secondary refining industries, aluminum generally exits the electrolysis reduction cell or melting furnace before being cooled and formed into one or more bulk aluminum products for shipping. To create bulk aluminum product, strip casters may extrude a long ingot or log of aluminum or die casts may form the aluminum into ingots. Operators may then press the ingots into plates, rolls, or extrude and cut the ingots into smaller segments for transfer to tertiary manufacturing facilities.

The tertiary aluminum industry involves forming bulk aluminum into equipment parts and consumer goods. Some of the bulk aluminum, particularly the rolls and plates, may be cut, stamped, lathed, drawn, machined, and partially extruded into final products (e.g. aluminum cans, car frame components, cookware). Operators may subject other bulk aluminum to various casting processes to produce a marketable product (e.g. engine blocks, airplane landing gear, wheel wheels, and other complex shapes). Typical casting processes may include the high pressure die cast, low pressure die cast, permanent mold, sand molding, lost foam, V process, and investment casting.

The various casting processes generally require a ready supply of molten aluminum. A tertiary production facility may receive ingots from a primary or secondary aluminum producer. The tertiary producer then melts the ingots and may further adjust the aluminum composition to create an alloy with properties desirable for a particular cast product. Once melted, operators may temporarily store the aluminum in one or more electric immersion holding furnaces. A holding furnace is typically associated with one or two casting lines. In each holding furnace, operator may regulate aluminum temperatures, alter the aluminum's chemical composition, and adjust other physical and chemical properties prior to casting.

Aluminum casting alloys may contain silicon, iron, manganese, magnesium, and other natural elements. Each alloy may provide structural integrity and other physical properties desirable in a particular casting. For example, in automobile transmission casting, operators may use alloy 383, which can consist of 9.5% to 11% silicon, 1.3% iron, 2% to 3% copper, 0.5% manganese, 1% magnesium, 0.3% nickel, 3% zinc, 15% tin, 0.5% other elements, and aluminum as the remaining percentage.

These elements however have the tendency to segregate out of solution and precipitate around non-metallic impurities. For example, alloy 383 generally has a specific gravity of 2.71. Less dense impurities, such as light gamma oxides with a specific gravity of about 2.35 generally precipitate quickly at the surface of the molten aluminum. To remove these impurities, an operator typically extends a ladle into an opening at the top of the holding furnace to draw out the less dense impurities manually. Insulation from refractor walls and coatings on the ladle itself can be common sources of less dense impurities.

Denser impurities, such as corundum, and complex intermetallic compounds, which may include compounds of aluminum, silicon, manganese, and chromium, may have higher specific gravities (e.g. about 4.0 for corundum) and can precipitate in suspension. This denser intermetallic “sludge” can accumulate around any immersed heating tubes and along the inner refractory walls of the holding furnace.

Over time, this sludge accumulation effectively reduces the volume of the holding furnace's holding chamber. Generally, holding furnaces can remain operable with about six to ten inches of aluminum in the holding chamber. When the aluminum approaches or drops below six to ten inches, operators generally refill the holding furnace with new aluminum from a melting furnace. If the operators do not refill the holding furnace, the draw bucket that removes the aluminum from the holding furnace, may not be filled to capacity. As a result, the casts may be insufficiently filled.

The time required to accommodate multiple pours into a single cast may result in portions of the cast cooling inconsistently, which could create structural weakness in the final cast part. Further, a pre-maturely shallowed holding chamber in an holding furnace could encourage replenishing the holding chamber with aluminum more frequently. Frequently replenishing aluminum stock to maintain output wastes energy. Additionally, each new bucket of aluminum generally contains new impurities. The more frequently operators waste energy replenishing the aluminum, the more the operators contribute to sludge accumulation and the more effectively the operators reduce the holding chamber's volume. As a result, even frequent replacement eventually becomes insufficient to maintain product output. Therefore, operators eventually deactivate the casting line to repair or replace the holding furnace. These maintenance periods contribute to production loss.

In addition to accumulating along the refractory walls of the holding chamber, corundum and sludge typically accumulates around the immersed heating tubes. The immersed heating tubes are typically made from silicon nitride, or silicon carbide. The sludge accumulations can absorb heat, which may render the heating tubes less effective at regulating the aluminum's temperature. The consistency at which operators pour aluminum into a cast can affect the final cast product's physical properties.

When operators deactivate a holding furnace for maintenance, the operators typically drain the aluminum, allow the holding furnace to cool, and manually dislodge the corundum and other sludge accumulations around the immersion tubes with a shaft or other prodding device. With manual cleaning, operators frequently break one or more immersion tubes and thereby expose the electric heating element. Molten aluminum would destroy an exposed heating element. Therefore, operators typically replace at least the broken immersion tubes before reactivating the holding furnace. Replacing a broken immersion tube contributes to production loss, especially if the operators do not have available spare immersion tubes on site.

To minimize production loss, some production facilities have taken to purchasing reserve holding furnaces. The reserve holding furnaces may be exchanged with the used holding furnace. Holding furnaces commonly weigh between 8,000 pounds (“lbs.”) and 40,000 lbs. Each may be installed with a large fork truck or crane. An electric furnace's weight creates safety risks to installing personnel and encourages slow and careful installation to mitigate this risk, which can further increase production loss.

### SUMMARY OF THE INVENTION

The problem of loss of production due to immersed heating tube failure caused by physical breakage of an immersed heating tube in an electric immersion heating furnace, the problem of reduced aluminum temperature regulation due to corundum and sludge accumulation around the immersed heating tubes in the furnace chamber, and the problem of reduced capacity in an electric immersion holding furnace due to sludge and corundum accumulation in the holding chamber is solved by circulating aluminum smoothly in the holding chamber in a horizontal direction such that the aluminum moves around the immersion heating tubes and holding chamber.

Without being bounded by theory, a stirring assembly configured to circulate aluminum in an electric immersion holding furnace smoothly may provide a more uniform metal temperature and density distribution in the holding chamber and thereby reduce temperature and density gradients, which may contribute to the formation of sludge and corundum.

It will be understood that “electric immersion holding furnace” may refer to holding furnaces having heating elements configured to be immersed in liquid aluminum, e.g. the metal bath in the holding chamber. These heating elements generally emit sufficient heat to maintain the aluminum in a liquid state and to regulate the aluminum's temperature; however, the heating elements are generally not configured to impart sufficient energy to melt solid aluminum. For example, a melting furnace (which can also be referred to as smelting furnace) is typically a furnace that melts solids aluminum and other metals. A melting furnace may produce melt zone temperatures upwards of 2,100° F. with metal temperatures upwards of 1,500° F. An electric immersion holding furnace, such as the exemplary electric immersion holding furnaces described herein, may generate temperatures ranging from about 1,200° F. to about 1,400° F.

The immersion heating tubes used in an exemplary electric immersion holding furnace are generally made of a high grade silicon nitride. The silicon nitride is generally poured or pressed into a mold to create a tube structure closed at one end. The immersion tube has approximately a quarter inch wall thickness and allows for an electric heating element to be inserted in the immersion tube inner diameter (ID). The immersion tube generally has a contoured shape at the closed end in order to seal the immersion tube. The sealed end of the immersion tube generally extends into the holding chamber without contacting the opposing refractory wall or bottom (e.g. insulated floor) of the furnace chamber. The closed end also seals the electric heating element within the immersion tube and protects the electric heating element from the surrounding liquid aluminum. The electric heating element may be either a metallic or silicon carbide element designed to fit inside the immersion tubes.

The impeller may be configured to facilitate a smooth metal flow maintaining high quality alloy homogeneity and thereby greatly minimize alloy segregation and sludge buildup. The impeller or stirring head can be located slightly below the immersion heating tube to facilitate a uniform flow of aluminum. The shaft may engage a gearbox. In other exemplary embodiments, the shaft may engage a direct motor drive.

The impeller may engage a second end of a shaft extending through the holding furnace and a first end of the shaft may engage a gearbox, or a direct drive motor. The shaft may be a drive shaft. In other exemplary embodiments a gearbox may engage the body of the shaft to configure the shaft to spin the impeller at different rates of speed. In other exemplary embodiments, the gearbox may reverse the direction the impeller spins. In still other exemplary embodiments, a stirrer adjustment mechanism may engage the drive shaft to change the height of the shaft and the location of the impeller in the holding chamber relative to the bottom of the holding chamber. In other exemplary embodiments, the stirrer adjustment mechanism may change the position of the shaft and impeller within the holding chamber, such as by pivoting the shaft around a point, by moving the shaft and impeller laterally within the holding chamber, or a combination thereof.

Rotary de-gassers can be used in the industry to lift soluble hydrogen out of the metal above the level of the metal, where the hydrogen can be collected and removed. A de-gasser may disperse small bubbles of nitrogen, argon, or salt agents to de-gas in this manner. De-gassers may have rotary elements configured to rotate at 200 to 400 rotations per minute (r.p.m.). A de-gasser may be used at the outlet of the electric immersion holding furnace, but not in the holding chamber below the immersion tubes. If a de-gasser were used in the holding chamber proximate to the exemplary stirring assembly disclosed herein, the de-gasser and the stirrer assembly would excessively agitate the metal and create undesirable surface oxides. These surface oxides would negatively affect the integrity of the metal when cast. Accordingly, the stirrer assembly disclosed herein is not configured to de-gas the metal. Moreover, the exemplary stirrer assembly is configured to rotate the impeller in a range between 150 rpm to 300 rpm.

can be used in degassing the metal, such as in the exit well, where the metal is extracted from, but such de-gassers would not be used in the holding chamber and the stirrer assembly is not configured to de-gas the metal in the holding chamber, due to the creating of surface oxides. Accordingly, the shaft may be solid, and not hollow.

In an exemplary embodiment, a holding furnace is provided. The holding furnace may have walls defining a furnace chamber. At least one immersion tube can be disposed horizontally within the furnace chamber. In other exemplary embodiments, the holding furnace may comprise more than one immersion tube. The immersion tubes may contain silicon nitride, silicon carbide, a combination thereof, or other materials configured to conduct energy while withstanding the temperatures within the furnace chamber. In an exemplary system, an inert cover gas disposed over the surface of the liquid metal may be used to minimize metal surface oxidation.

The stirring assembly may have a solid graphite or silicon nitride shaft with a impeller that rotates, thereby creating the movement of metal, preventing alloy segregation, and the accumulation of sludge beneath the heater tubes. In other exemplary embodiments, the shaft may be made of concrete or other material configured to withstand the temperatures and pressures of an electric immersion holding furnace. In certain exemplary embodiments, the shaft may be engaged to a gearbox that allows operators to rotate the impeller in a clockwise direction and alternatively in a counter-clockwise direction. In other exemplary embodiments, two or more impellers may be disposed along a shaft. The shaft and impellers may be configured to rotate in the same direction or alternatively, a first impeller may rotate in a first direction while a second impeller may be configured to rotate in a second direction. Impeller speed may be controlled so as not to create turbulent flow and thereby greatly diminish the creation of undesirable sludge impurities in the aluminum. Metal movement may additionally draw out energy from the surface of the immersion tube into the metal, and thereby reduce energy consumption. Energy is commonly measured in British Thermal Units (“BTU's”)

A motor or gearbox may provide for unidirectional or reversal of the impeller shaft so not to accumulate sludge and corundum in corners. In certain exemplary embodiments, the refractory insulated walls have rounded corners to aid in smooth movement of metal throughout the furnace chamber. The impeller desirably does not spin with such angular velocity that the impeller pulls impurities down from the surface of the aluminum in the holding chamber to create oxides and other impurities that would affect metal quality.

In accordance with the embodiments described and contemplated herein, present disclosure may improve energy efficiency in electric immersion holding furnaces.

The exemplary embodiments may further prevent alloy segregation within the electric immersion holding furnace.

The exemplary embodiments may additionally prevent the accumulation of sludge, corundum, and other accumulations around the immersion heating elements.

The exemplary embodiments may additionally allow for more even temperature distribution within the holding chamber as the metal passes over the immersion heating elements and circulates within the holding chamber.

The exemplary embodiments disclosed herein may prolong the operational life of heating elements by preventing the breaking of immersion heating elements, particularly immersion heating elements comprised of silicon nitride, due to manual dislodgement of corundum and other sludge accumulations during electric immersion holding furnace maintenance periods.

### BRIEF DESCRIPTION OF THE DRAWINGS

The foregoing will be apparent from the following more particular description of exemplary embodiments of the disclosure, as illustrated in the accompanying drawings in which like reference characters refer to the same parts throughout the different views. The drawings are not necessarily to scale, with emphasis instead being placed upon illustrating the disclosed embodiments.

FIG. 1 is a perspective view of an exemplary electric immersion holding furnace.

FIG. 2 is a cross-sectional side view that shows the length of an exemplary electric immersion holding furnace while depicting the stirring assembly disposed below horizontal heating elements.

FIG. 3. is a perspective view of an exemplary stirrer assembly depicting an exemplary impeller configured to move the metal in a substantially horizontal manner

FIG. 4 is a cross-sectional side view that depicts the width of an exemplary electric immersion holding furnace, while showing a horizontal heating element extending partially into the holding chamber above the stirring assembly.

### DETAILED DESCRIPTION OF THE INVENTION

The following detailed description of the preferred embodiments is presented only for illustrative and descriptive purposes and is not intended to be exhaustive or to limit the scope and spirit of the invention. The embodiments were selected and described to best explain the principles of the invention and its practical application. One of ordinary skill in the art will recognize that many variations can be made to the invention disclosed in this specification without departing from the scope and spirit of the invention.

Corresponding reference characters indicate corresponding parts throughout the several views. Although the drawings represent embodiments of various features and components according to the present disclosure, the drawings are not necessarily to scale and certain features may be exaggerated in order to better illustrate embodiments of the present disclosure, and such exemplifications are not to be construed as limiting the scope of the present disclosure in any manner.

It will be understood that “aluminum” may refer to either pure elemental aluminum or alloys comprising aluminum unless otherwise specifically stated in an example.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Although specific terms are used in the following description for the sake of clarity, these terms are intended to refer only to the particular structure of the embodiment selected for illustration in the drawings, and are not intended to define or limit the scope of the disclosure.

The singular forms “a,” “an,” and “the” include plural referents unless the context clearly dictates otherwise. Numerical values should be understood to include numerical values which are the same when reduced to the same number of significant figures and numerical values which differ from the states value by less than the experimental error of conventional measurement technique of the type described in the present application to determine the value.

All ranges disclosed herein are inclusive of the recited endpoint and are independently combinable (for example, the range “from 2 degrees to 10 degrees” is inclusive of the endpoints, 2 degrees and 10 degrees, and all intermediate values.

As used herein, approximating language may be applied to modify any quantitative representation that may vary without resulting in a change in the basic function to which it is related. Accordingly, a value modified by a term or terms, such as “about” and “substantially,” may not be limited to the precise values specified. The modifier “about” should also be considered as disclosing the range defined by the absolute values of the two endpoints. For example the expression “from about 2 to about 4” also discloses the range “from 2 to 4.”

It should be noted that many of the terms used herein are relative terms. For example, the terms “upper” and “lower” are relative to each other in location, i.e. an upper component is located at a higher elevation than a lower component in a given orientation, but these terms can change if the device is flipped. The terms “inlet’ and “outlet” are relative to a fluid flowing through them with respect to a given structure, e.g. a fluid flows through the inlet into the structure and flows through the outlet out of the structure. The terms “upstream” and “downstream” are relative to the direction in which a fluid flows through various components, i.e. the flow of fluids through an upstream component prior to flowing through the downstream component.

The terms “horizontal” and “vertical” are used to indicate direction relative to an absolute reference, i.e. ground level. However, these terms should not be construed to require structure to be absolutely parallel or absolutely perpendicular to each other. For example, a first vertical structure and a second vertical structure are not necessarily parallel to each other. The terms “top” and “bottom” or “base” are used to refer to locations/surfaces where the top is always higher than the bottom/base relative to an absolute reference, i.e. the surface of the Earth. The terms “upwards” and “downwards” are also relative to an absolute reference; an upwards flow is always against the gravity of the Earth.

The term “directly,” wherein used to refer to two system components, such as valves or pumps, or other control devices, or sensors (e.g. temperature or pressure), may be located in the path between the two named components.

An aluminum melting furnace, which is also known as an aluminum smelting furnace, generally melts aluminum prior to the aluminum entering one or more electric immersion holding furnaces. The melting furnace may produce melt zone temperatures upwards of 2,100° F. with metal temperatures upwards of 1,500° F. By contrast, an electric immersion holding furnace is generally designed to store the aluminum and aluminum alloys in liquid form while the metal awaits further processing. An electric immersion holding furnace may generate temperatures ranging from about 1,200° F. to about 1,400° F. The desired aluminum generally resides at the bottom of the furnace where troughs or large buckets may convey the molten aluminum to one or more holding furnaces.

Generally, an electric immersion holding furnace is associated with a caster.

Occasionally, one electric immersion holding furnace may be associated with two or possibly three casters, but it is generally uncommon in the industry to have a single electric immersion holding furnace connected to more than three casters. As a result, in production facilities that utilize many casters, it is common to have about as many electric immersion holding furnaces configured to supply liquid metal to the associated caster.

An exemplary electric immersion holding furnace with exemplary circulating means as disclosed herein may be configured to be used with any commonly used casting techniques. These techniques may include for example, high pressure die casting, low pressure die casting, permanent molding, sand molding, lost foam molding, the V process, and investment casting.

In die casting, a reusable steel mold forms aluminum into castings under high pressure. Operators or equipment generally inject molten metal in to the die (mold) where the metal is rapidly chilled. The die cast machines are normally classified as horizontal or vertical

In low pressure casting, pressurized air in an air tight furnace containing molten metal forces the metal up a refractory tube and into a permanent mold mounted over the furnace. The pressure is typically less than 15 pounds per square inch (“PSI”). This casting process typically eliminates the need for risers and heavy gating. Aluminum wheels are commonly produced by a low pressure casting system.

Permanent mold castings represent about 15% of the casting poured. In permanent mold casting, operators and equipment pour aluminum into permanent metal molds under gravity. Metal molds are made of high alloy iron or steel and have typically production life of upward 125,000 castings.

In sand mold casting, operators and equipment pour molten aluminum into green sand molds or chemically bonded molds. This is considered a gravity pour casting, like permanent mold, but more complex castings can be produced in sand using sand cores.

Aluminum sand castings represent about 11% of the aluminum castings produced in the world. The sand mold generally cannot be reused.

In lost foam casting, operators and equipment use gravity to pour aluminum into an unbounded sand flask formed around a polystyrene mold. The foam pattern is a duplicate of the castings to be produced. As the aluminum is poured into the sand flask, the polystyrene mold evaporates and the aluminum sets in the form of the foam pattern. This is process is also called EPC which represents expendable pattern castings.

In investment casting, a wax pattern stands in for the final aluminum casting and a plaster mold is created around the wax pattern. The plaster mold is a refractory mold that as the inverse shape of the final aluminum casting. Prior to adding the aluminum, operators and equipment burn out the wax, thereby leaving the refractory plaster or ceramic mold in the exact shape of the casting to be produced. The molten aluminum is then poured into the refractory mold to produce high tolerance castings.

The following detailed description of the preferred embodiments is presented only for illustrative and descriptive purposes and is not intended to be exhaustive or to limit the scope and spirit of the invention. The embodiments were selected and described to best explain the principles of the invention and its practical application. One of ordinary skill in the art will recognize that many variations can be made to the invention disclosed in this specification without departing from the scope and spirit of the invention.

Corresponding reference characters indicate corresponding parts throughout the several views. Although the drawings represent embodiments of various features and components according to the present disclosure, the drawings are not necessarily to scale and certain features may be exaggerated in order to better illustrate embodiments of the present disclosure, and such exemplifications are not to be construed as limiting the scope of the present disclosure in any manner.

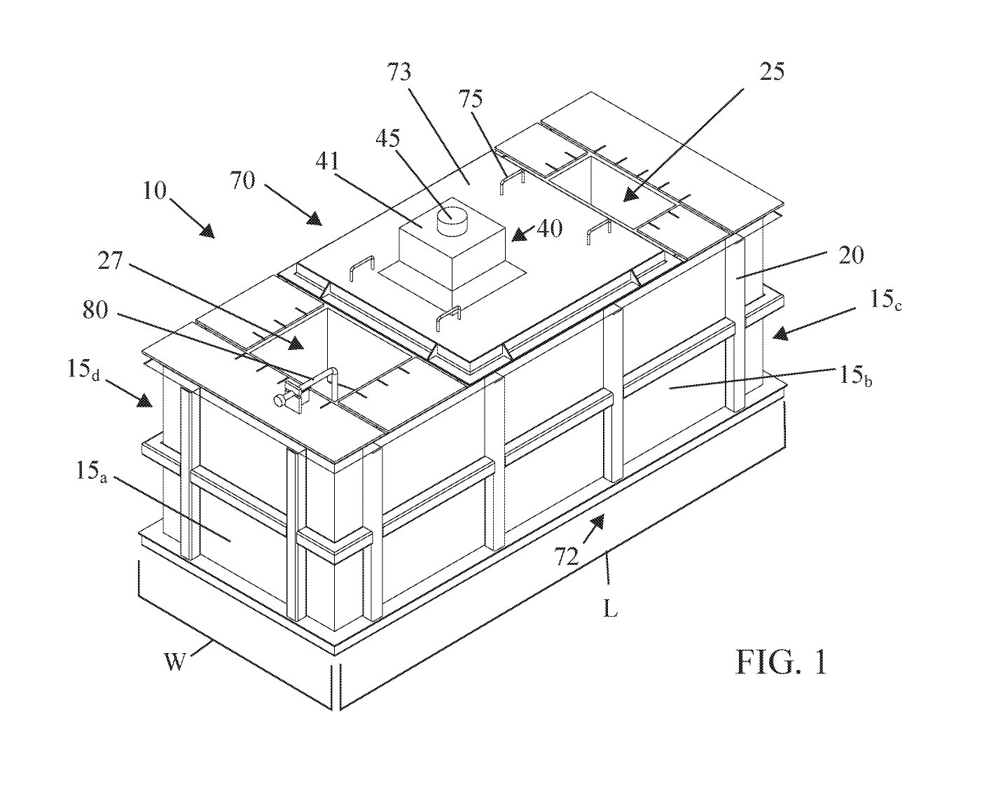

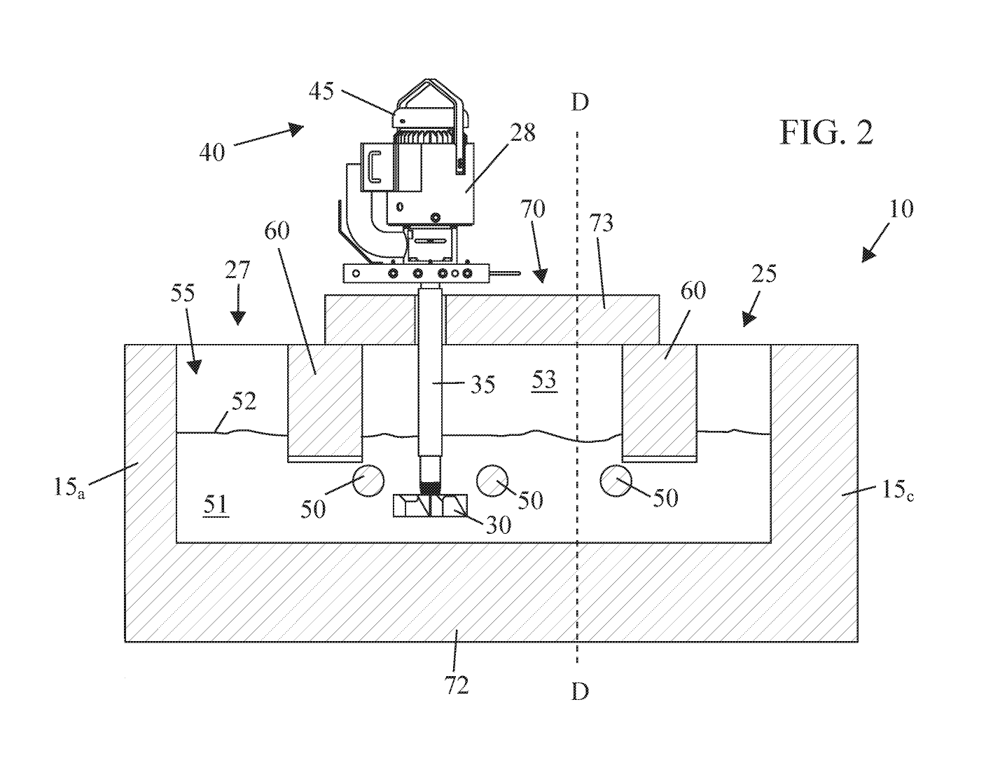

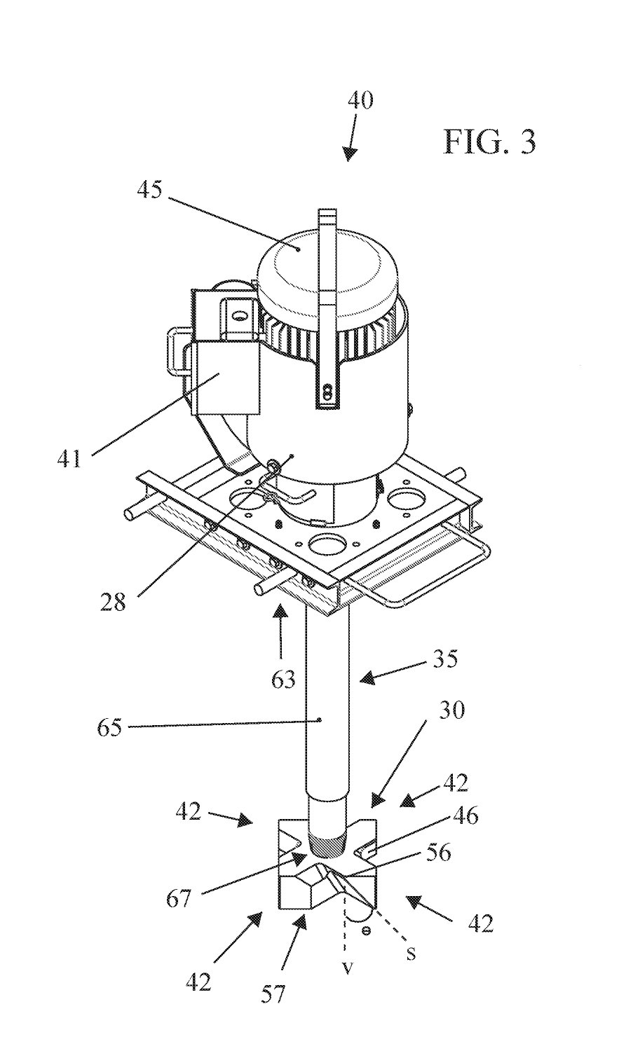

FIG. 1 is a perspective view of an electric immersion holding furnace 10. Operators may pour molten metal into an inlet 25 in the top 70 of the electric immersion holding furnace 10. The electric immersion holding furnace 10 comprises Refractory walls 15 bounded by supports 20. Exemplary electric immersion holding furnaces 10 typically resemble a rectangular prism, but nothing in this disclosure limits the shape of the electric immersion holding furnace 10 or the holding chamber 55. In the depicted embodiment, a first small refractory wall 15ₐ is disposed opposite a second small refractory wall 15_{c}. Together, the first small refractory wall 15ₐ and the second small refractory wall 15_{c} define a width W of the electric immersion holding furnace 10. Likewise a first large refractory wall 15_{b} is disposed opposite to a second large refractory wall 15_{d}. Together, the first large refractory wall 15_{b} and the second large refractory wall 15_{d} define a length L of the electric immersion holding furnace 10. The refractory walls 15 engage the insulated floor 72 of the electric immersion holding furnace 10 to define a holding chamber 55 (FIG. 2). The holding chamber 55 may further comprise a top 70 of the electric immersion holding furnace 10 disposed above arches 60 (FIG. 2) extending into the holding chamber 55. To facilitate horizontal movement of the metal 51 (FIG. 2) within the holding chamber 55 in accordance with the exemplary embodiments disclosed herein, a stirrer assembly 40 (see FIG. 3 for more detail) is provided. The stirrer assembly 40 may comprise a motor 45 disposed in or atop a gearbox 41. The gearbox 41 may engage the top 70 of the electric immersion holding furnace 10 directly. The motor 45 and gearbox 41 are preferably disposed outside of the holding chamber 55. The metal 51 within the holding chamber 55 may be aluminum, an aluminum alloy, or other molten metal or metal alloy used in metal casting.

The electric immersion holding furnace 10 may further comprise a thermocouple 80. The thermocouple 80 extends into the holding chamber 55 to regulate the metal's temperature. When the metal 51 is needed for further processing, dip ladles (not depicted) collect the molten metal through an outlet 27 in the top 70 of the electric immersion holding furnace 10. Lifting brackets 75 may be used to raise the cover 73 for cleaning.

Electric immersion holding furnaces 10 typically heating elements that provide less radiant and convection heat than melting furnaces. When the electric immersion holding furnace is configured to hold aluminum, the electric immersion holding furnace 10 may maintain temperatures above 1,150 degrees Fahrenheit (“° F.”) and typically between 1,200° F. to 1,400° F. depending on the aluminum or aluminum alloy to keep the aluminum or aluminum alloy at the desired casting temperature. Electric immersion holding furnaces 10 typically have electric heating elements placed in immersion tubes 50. The immersion tubes 50 typically extend through the holding chamber 55 any may contact the molten metal 51 in the holding chamber 55. Operators can adjust the heat output of the electric heating elements and thereby regulate the temperature in the electric immersion holding furnace 10 to control the metal's consistency prior to casting.

FIG. 2 is a cross sectional side view of an exemplary electric immersion holding furnace 10 bisected along the length L (FIG. 1). In this exemplary embodiment, the heating elements and immersion tubes 50 are horizontally disposed. In other exemplary embodiments, the immersion tubes 50 may extend into the holding chamber 55 at an angle relative to a horizontal line. Although the immersion tube 50 depicted appears generally cylindrical with a domed end, it will be understood that an immersion tube 50 may be polyhedral in shape, including but not limited to a rectangular polyhedron, have a generally oval profile, extend into the metal as a helix, or have helical sections, be generally conical in shape, or otherwise configured to encompass a heating element. Molten metal 51 immerses the immersion tubes 50. Arches 60 partially divide the holding chamber 55. The arches 60 may comprise the same material as the refractory walls 15. The refractory walls 15 are generally insulated walls and may comprise castable refractory, brick, or other material configured to withstand the pressures and temperatures within the electric immersion heating furnace 10. The metal 51 generally defines a level 52 with a pocket of gas 53 above the level 52. The stirring assembly 40 generally comprises the motor 45 communicating with a gearbox 41, shaft 35 and impeller 30. In certain exemplary embodiments, the shaft 35 may be a silicon nitride shaft. In other exemplary embodiments, the shaft 35 may be a silicon carbide shaft. In other exemplary embodiments, the shaft 35 may be comprised of graphite. In still other exemplary embodiments, the shaft 35 may comprise a material configured to withstand the pressure and heat in the holding chamber 55 (e.g. concrete graphite, an alloy or composite material containing silicon carbide or silicon nitride). The impeller 30 extends below the immersion tubes 50 and may rotate in a clockwise or counter clockwise direction. The rate at which the impeller 30 rotates may vary depending on the configuration of the gearbox 41. The impeller 30 is configured to move the liquid metal 51 under and around the immersion tubes 50, preferably horizontally. In certain exemplary embodiments, the impeller 30 may rotate substantially constantly while metal 51 is in the electric immersion holding furnace 10. In other exemplary embodiments, the impeller 30 may rotate intermittently. In exemplary embodiments in which the impeller 30 rotates intermittently, the impeller 30 may rotate at predetermined internals. In other exemplary embodiments, the electric immersion holding furnace 10 may further comprise a sludge detector and the impeller 30 may rotate in response to detected sludge accumulations around the immersion tubes 50.

FIG. 3 is a perspective view of an exemplary stirring assembly 40. The motor 45 is disposed within a motor housing 28. The motor 45 is a three to five horse power motor 45 and the shaft 35 is comprised of oxide-resistant impregnated graphite. The shaft 35 has a first end 63, a second end 67, and a body 65. In the depicted embodiment, the first end 63 engages the motor 45 directly. The body 65 extends through the top 70 of the electric immersion holding furnace 10 and into the holding chamber 55 below the immersion tube 50. The impeller 30 may rotate in a range between 150 rpm to 300 rpm

The second end 67 engages the impeller 30 suspended in the holding chamber 55 below the immersion tube 50. The second end 67 may comprise a screw and the impeller 30 may engage the second end 67 through a complementary screw. In embodiments in which the stirring assembly 40 is configured to rotate bi-directionally, the impeller 30 may be pinned to the second end 67 of the shaft 35. The motor 45 rotates the shaft 35 and impeller 30 such that the impeller 30 circulates molten metal 51, or molten aluminum across the immersion tube 50 in a substantially horizontal direction. The exemplary impeller 30 is comprised of graphite and has multiple of arms 42 configured to move the metal 51 in a horizontal direction. The arms 42 may be machined. The arms 42 may comprise a surface 46 having a negative slope s, wherein the slope s is disposed at a slope angle θ, and wherein the slope angle θ is defined by the angle of the surface 46 relative to a vertical line v extending from a top corner 56 of an arm 42 to the bottom 57 of the arm 42. The slope angle θ may be in a range of 15 degrees to 75 degrees with respect to the vertical line v, preferably 15 degrees to 45 degrees. The slope angle θ may be selected based on the dimensions of the holding chamber 55 and the position of the impeller 30 within the holding chamber 55. In the depicted embodiment, the stirring assembly 40 is disposed substantially vertically with the impeller 30 extending below the immersion tubes 50. In other exemplary embodiments, the electric immersion holding furnace may have the stirring assembly 40 disposed at an angle relative to the vertical line v. In still other exemplary embodiments, the impeller 30 may be disposed at an angle relative to the vertical line v between 0 degrees and 180 degrees. An exemplary angle may be 90 degrees.

In other exemplary embodiments a gearbox 41 or a speed controlled direct drive motor 45 may engage the body 65 of the shaft 35 to configure the shaft 35 to spin the impeller 30 at different rates of speed. In other exemplary embodiments, the gearbox 41 or a motor 45 may reverse the direction the impeller 30 spins. In still other exemplary embodiments, a stirrer adjustment mechanism may engage the shaft 35 to change the height of the shaft 35 and the location of the impeller 30 in the holding chamber 55 relative to the insulated floor 72 of the holding chamber 55. In other exemplary embodiments, the stirrer adjustment mechanism may change the position of the shaft 35 and impeller 30 within the holding chamber 55, such as by pivoting the shaft 35 around a point, by moving the shaft 35 and impeller 30 laterally within the holding chamber 55, or a combination thereof.

Alternative embodiments may have more than one immersion stirring assembly 40. Other embodiments may utilize pumps to circulate the metal 51. Means for circulating the metal 51 may include the exemplary stirring assemblies 40 embodiments described herein, exemplary impellers 30, pumps, baffles that extend partially or completely into the metal 51, immersion tubes 50 pivotally mounted the electric immersion holding furnace that vibrate or move in a linear or rotary direction, or pivotally mounted stirring mechanisms configured to allow the shaft 35 of the stirring assembly 40 to move around a fixed point.

A device that circulates the metal 51 in an electric immersion holding furnace 10 to prevent corundum accumulation around the immersion tubes and inner walls is considered to be within the scope of this disclosure.

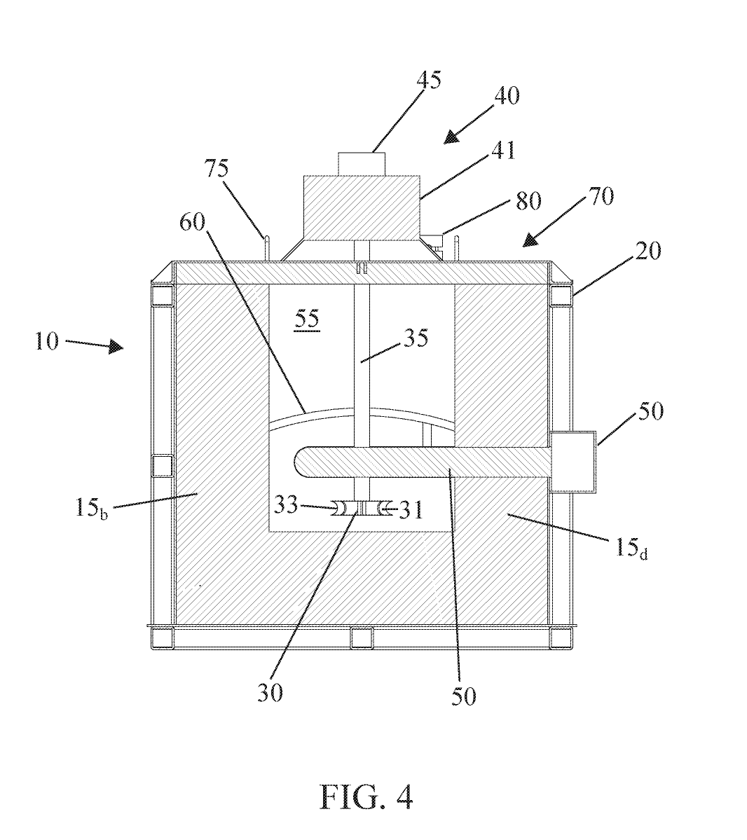

FIG. 4 is a cross sectional side view of the electric immersion holding furnace 10 intersected along line D-D (FIG. 2). In this exemplary embodiment, the immersion tubes 50 extend into the holding chamber 55 through second large refractory wall 15_{d} but do not contact the first large refractory wall 15_{b}. In other exemplary embodiments, at least one of the immersion tubes 50 may contact the second large refractory wall 15_{d} and the first large refractory wall 15_{b}. In yet other exemplary embodiments, the immersion tubes 50 may engage one or both of the small refractory walls 15ₐ, 15_{c}. In still other exemplary embodiments, the immersion tubes 50 may be vertically disposed or diagonally disposed relative to a horizontal line extending through the holding chamber 55 (see the level 52, FIG. 2). In other exemplary embodiments, the immersion tubes 50 may be partially immersed within the liquid metal 51. It will be understood that any of the example embodiments disclosed herein may be used singularly or in combination with any of the other exemplary embodiments disclosed herein where such combination permits the electric immersion holding furnace 10 to function as a vessel for holding molten metal 51.

As further depicted in FIG. 4, the exemplary impeller 30 may comprise a series of paddles 31 extending radially from the shaft 35. The paddles 31 may comprise a concave end 33 distally disposed from the shaft 35. Impellers 30 configured with paddles 31 having concave ends 33 and rotating with the shaft 35 may promote horizontal movement of the metal 51 within the holding chamber 55, and desirably, uniform horizontal movement.

An exemplary system may comprise: an electric immersion holding furnace having refractory walls engaging an insulated floor, wherein the refractory walls engaging the insulated floor define a holding chamber; a heating element disposed within an immersion tube, wherein the immersion tube extends into the holding chamber; and means for circulating molten metal within the electric immersion holding furnace in a substantially horizontal direction.

An exemplary electric immersion holding furnace may comprise: refractory walls operatively connected to an insulated floor, wherein the refractory walls and insulated floor define a holding chamber; an immersion tube, extending through a refractory wall and disposed within the holding chamber; a motor operatively engaged to a first end of a shaft, wherein the motor is disposed outside of the electric immersion holding furnace; a shaft having the first end, a second end, and a body engaging the first end and second end, the body extends into the holding chamber below the immersion tube, and the second end engages an impeller suspended in the holding chamber below the immersion tube, wherein the motor rotates the shaft and impeller such that the impeller circulates liquid metal throughout the holding chamber and across the immersion tube in a substantially horizontal direction.

An exemplary electric immersion holding furnace may further comprise a gearbox engaged to the motor, wherein the gearbox is a variable speed gearbox and the motor is a bi-directional motor. An exemplary electric immersion holding furnace may further comprise a plurality of immersion tubes, wherein an electric heater is disposed within each of the plurality of immersion tubes, and wherein the plurality of immersion tubes are disposed horizontally with the holding chamber. a gearbox may be configured to adjust a length of the shaft extending into the holding chamber.

In an additional exemplary embodiment, the electric immersion holding furnace the motor is disposed on a top of the electric immersion holding furnace such that the shaft body extends through the top of the electric immersion holding furnace and the second end engages the impeller below the immersion tube. In additional embodiments, the electric immersion holding furnace may further comprise multiple stirring assemblies.

An exemplary electric immersion holding furnace may have an impeller further comprising a plurality of arms, wherein the arms comprise a surface having a negative slope defined by a slope angle, and wherein the slope angle is the angle of the surface relative to a vertical line extending from a top corner of an arm to the bottom on the arm. In other exemplary embodiments, the impeller may further comprise paddles extending radially from the shaft, wherein the paddles further comprise a concave end distally disposed from the shaft.

An exemplary method for preventing sludge and corundum accumulation on immersion tubes in an electric immersion holding furnace may comprise: circulating the metal in a horizontal plane in a holding chamber disposed within an electric immersion holding furnace.

While this invention has been particularly shown and described with references to exemplary embodiments thereof, it will be understood by those skilled in the art that various changes in form and details may be made therein without departing from the scope of the invention encompassed by the appended claims.

What is claimed is:

1. A system comprising:
an electric immersion holding furnace having refractory walls engaging an insulated floor, wherein the refractory walls engaging the insulated floor define a holding chamber;
a heating element disposed within an immersion tube, wherein the immersion tube extends into the holding chamber; and
means for circulating molten metal within the electric immersion holding furnace in a substantially horizontal direction.

2. The system of claim 1, wherein the immersion tube further comprises silicon nitride.

3. The system of claim 1, wherein the immersion tube further comprises silicon carbide.

4. The system of claim 1, wherein the immersion tube further comprises silicon nitride and a compound configured to withstand the heat of the electric immersion holding furnace.

5. An electric immersion holding furnace comprising:
refractory walls operatively connected to an insulated floor, wherein the refractory walls and insulated floor define a holding chamber;
an immersion tube, extending through a refractory wall and disposed within the holding chamber;
a motor operatively engaged to a first end of a shaft, wherein the motor is disposed outside of the electric immersion holding furnace;
a shaft having the first end, a second end, and a body engaging the first end and second end, the body extends into the holding chamber below the immersion tube, and the second end engages an impeller suspended in the holding chamber below the immersion tube, wherein the motor rotates the shaft and impeller such that the impeller circulates liquid metal throughout the holding chamber and across the immersion tube in a substantially horizontal direction.

6. The electric immersion holding furnace of claim 5, further comprising a gearbox engaged to the motor, wherein the gearbox is a variable speed gearbox and the motor is a bi-directional motor.

7. The electric immersion holding furnace of claim 5 further comprising arches that extend into the holding chamber to create holding spaces.

8. The electric immersion holding furnace of claim 5 further comprising a plurality of immersion tubes, wherein an electric heater is disposed within each of the plurality of immersion tubes, and wherein the plurality of immersion tubes are disposed horizontally with the holding chamber.

9. The electric immersion holding furnace of claim 8, wherein a gearbox is configured to adjust a length of the shaft extending into the holding chamber.

10. The electric immersion holding furnace of claim 5, wherein the motor is disposed on a top of the electric immersion holding furnace such that the shaft body extends through the top of the electric immersion holding furnace and the second end engages the impeller below the immersion tube.

11. The electric immersion holding furnace of claim 5, wherein the motor, shaft, and impeller comprise a stirring assembly and wherein the electric immersion holding furnace further comprises multiple stirring assemblies.

12. The electric immersion holding furnace of claim 5, wherein the immersion tubes contain either silicon nitride or silicon carbide and shaft is comprised of a material selected from the group consisting of graphite, castable refractory, silicon nitride, and silicon carbide.

13. The electric immersion holding furnace of claim 5, wherein the impeller further comprises a plurality of arms, wherein the arms comprise a surface having a negative slope defined by a slope angle, and wherein the slope angle is the angle of the surface relative to a vertical line extending from a top corner of an arm to the bottom on the arm.

14. The electric immersion holding furnace of claim 13, wherein the slope angle is in the range of 15 degrees to 45 degrees.

15. The electric immersion holding furnace of claim 5, wherein the impeller further comprises paddles extending radially from the shaft.

16. The electric immersion holding furnace of claim 15, wherein the paddles further comprise a concave end distally disposed from the shaft.

17. A method for preventing sludge and corundum accumulation on immersion tubes in an electric immersion holding furnace comprising:
circulating the metal in a horizontal plane in a holding chamber disposed within an electric immersion holding furnace.
